(19) United States
(12) Patent Application Publication
(10) Pub. No.: US 2026/0235713 A1
(43) Pub. Date: Aug. 13, 2026

(54) ACOUSTIC SENSOR ARRAY AND METHOD OF PROCESSING ACOUSTIC DATA COLLECTED BY THE SAME

(71) Applicant: VALEO COMFORT AND DRIVING ASSISTANCE, Créteil (FR)

(72) Inventor: Brandon Hook, Troy, MI (US)

(73) Assignee: VALEO COMFORT AND DRIVING ASSISTANCE, Créteil (FR)

(21) Appl. No.: 19/050,637

(22) Filed: Feb. 11, 2025

(51) Int. Cl. G01S 3/86

(52) U.S. Cl. CPC G01S 3/86

(57) ABSTRACT

A system includes an acoustic sensor array and digital signal processor. The acoustic sensor array includes two pairs of acoustic sensors, each of which includes two acoustic sensors. The acoustic sensor array is configured to detect and convert an acoustic wave to first through fourth acoustic data. The digital signal processor is configured to receive, from the acoustic sensor array, the first through fourth acoustic data. For each field of view, the digital signal processor is further configured to determine first beams using the first and second acoustic data and determine second beams using the third and fourth acoustic data. For each field of view, the digital signal processor is still further configured to determine first and second intermediate acoustic data independently using the first beams and second beams, respectively, and determine filtered acoustic data based on the first and second intermediate acoustic data.

### BACKGROUND

As autonomous vehicles advance, the need for what autonomous vehicles can detect, process, and react to advance. Autonomous vehicles not only need to be able to detect, process, and react to positional changes in driving conditions, such as changes in the positions of surrounding vehicles or roads, but also acoustic changes in driving conditions. That is, autonomous vehicles need to be able to both “see” and “hear” their surroundings to ensure save driving conditions are maintained.

It may be advantageous for autonomous vehicles to “hear,” for example, a sounding siren of a police car or ambulance. However, equipping autonomous vehicles to adequately “hear” the sounding siren may be challenging due to noise. Noise may be emitted from vehicle engines, vehicle tires, general traffic, construction, and wind. Wind and other uncorrelated signals may be especially difficult to attenuate.

Traditional noise attenuation methods may adequately attenuate the noise but at the cost of destroying the phase diversity of acoustic data that quantifies the acoustic wave emitting from the sounding siren. This phase diversity may be needed to use traditional angle-of-arrival methods that determine where the sounding siren is relative to the autonomous vehicle such that the autonomous vehicle may react to the sounding siren appropriately and in a short amount of time.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A system includes an acoustic sensor array and digital signal processor. The acoustic sensor array includes a first pair of acoustic sensors and second pair of acoustic sensors. The first pair of acoustic sensors includes a first acoustic sensor and second acoustic sensor. The first acoustic sensor has a first center. The second acoustic sensor has a second center. The first center is located at a first distance of 10 to 75 millimeters, inclusive, from the second center. The second pair of acoustic sensors includes a third acoustic sensor and fourth acoustic sensor. The third acoustic sensor has a third center. The fourth acoustic sensor has a fourth center. The third center is located at a second distance of 10 to 75 millimeters, inclusive, from the fourth center. The first pair of acoustic sensors has a fifth center. The second pair of acoustic sensors has a sixth center. The fifth center is located at a third distance of 75 to 400 millimeters, inclusive, from the sixth center. The first acoustic sensor is configured to detect an acoustic wave and convert the acoustic wave to first acoustic data. The second acoustic sensor is configured to detect the acoustic wave and convert the acoustic wave to second acoustic data. The third acoustic sensor is configured to detect the acoustic wave and convert the acoustic wave to third acoustic data. The fourth acoustic sensor is configured to detect the acoustic wave and convert the acoustic wave to fourth acoustic data. The digital signal processor is communicably coupled to the acoustic sensor array. The digital signal processor is configured to execute computer-readable code that causes the digital signal processor to receive, from the acoustic sensor array, the first acoustic data, the second acoustic data, the third acoustic data, and the fourth acoustic data. For each of two or more fields of view, the computer-readable code further causes the digital signal processor to determine, using the first distance, two or more first beams using the first acoustic data and the second acoustic data and determine, using the second distance, two or more second beams using the third acoustic data and the fourth acoustic data. The two or more first beams and two or more second beams are directed towards each of the two or more fields of view. For each of two or more fields of view, the computer-readable code still further causes the digital signal processor to determine first intermediate acoustic data and second intermediate acoustic data using the two or more first beams and the two or more second beams, respectively, and determine, using a third distance, filtered acoustic data based on the first intermediate acoustic data and the second intermediate acoustic data.

A vehicle includes a body, motor, acoustic sensor array, and digital signal processor. The motor is configured to propel the body. The acoustic sensor array is disposed and recessed, at least in part, within the body. The acoustic sensor array includes a first pair of acoustic sensors and second pair of acoustic sensors. The first pair of acoustic sensors includes a first acoustic sensor and second acoustic sensor. The first acoustic sensor has a first center. The second acoustic sensor has a second center. The first center is located at a first distance of 10 to 75 millimeters, inclusive, from the second center. The second pair of acoustic sensors includes a third acoustic sensor and fourth acoustic sensor. The third acoustic sensor has a third center. The fourth acoustic sensor has a fourth center. The third center is located at a second distance of 10 to 75 millimeters, inclusive, from the fourth center. The first pair of acoustic sensors has a fifth center. The second pair of acoustic sensors has a sixth center. The fifth center is located at a third distance of 75 to 400 millimeters, inclusive, from the sixth center. The first acoustic sensor is configured to detect an acoustic wave and convert the acoustic wave to first acoustic data. The second acoustic sensor is configured to detect the acoustic wave and convert the acoustic wave to second acoustic data. The third acoustic sensor is configured to detect the acoustic wave and convert the acoustic wave to third acoustic data. The fourth acoustic sensor is configured to detect the acoustic wave and convert the acoustic wave to fourth acoustic data. The digital signal processor is communicably coupled to the acoustic sensor array. The digital signal processor is configured to execute computer-readable code that causes the digital signal processor to receive, from the acoustic sensor array, the first acoustic data, the second acoustic data, the third acoustic data, and the fourth acoustic data. For each of two or more fields of view, the computer-readable code further causes the digital signal processor to determine, using the first distance, two or more first beams using the first acoustic data and the second acoustic data and determine, using the second distance, two or more second beams using the third acoustic data and the fourth acoustic data. The two or more first beams and two or more second beams are directed towards each of the two or more fields of view. For each of two or more fields of view, the computer-readable code still further causes the digital signal processor to determine first intermediate acoustic data and second intermediate acoustic data using the two or more first beams and the two or more second beams, respectively, and determine, using a third distance, filtered acoustic data based on the first intermediate acoustic data and the second intermediate acoustic data.

A method of using the system includes, using an acoustic sensor array, detecting an acoustic wave that includes an acoustic wave of interest emitted from a source of interest and converting the acoustic wave to first acoustic data, second acoustic data, third acoustic data, and fourth acoustic data. The method further includes, using a digital signal processor, receiving, from the acoustic sensor array, the first acoustic data, the second acoustic data, the third acoustic data, and the fourth acoustic data. The method still further includes, using the digital signal processor, for each of two or more fields of view, determining, using the first distance, two or more first beams using the first acoustic data and the second acoustic data and determining, using the second distance, two or more second beams using the third acoustic data and the fourth acoustic data. The two or more first beams and two or more second beams are directed towards each of the two or more fields of view. The method also includes, using the digital signal processor, for each of two or more fields of view, determining first intermediate acoustic data and second intermediate acoustic data using the two or more first beams and the two or more second beams, respectively, and determining, using a third distance, filtered acoustic data based on the first intermediate acoustic data and the second intermediate acoustic data.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a vehicle in accordance with one or more embodiments.

FIGS. 2 and 3 depict an acoustic sensor array in accordance with one or more embodiments.

FIGS. 4-6 depict a system in accordance with one or more embodiments.

FIG. 7 depicts a visualization of acoustic data in accordance with one or more embodiments.

FIGS. 8 and 9 depict coherence plots in accordance with one or more embodiments.

FIG. 10 depicts an illustrative example of a vehicle and acoustic sensor array in accordance with one or more embodiments.

FIG. 11 depicts a visualization of intermediate acoustic data in accordance with one or more embodiments.

FIG. 12 depicts a visualization of filtered acoustic data in accordance with one or more embodiments.

FIG. 13 depicts a flowchart of acoustic data in accordance with one or more embodiments.

FIG. 14 depicts a block diagram in accordance with one or more embodiments.

FIG. 15 depicts a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “an acoustic sensor” includes reference to one or more of such sensors.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

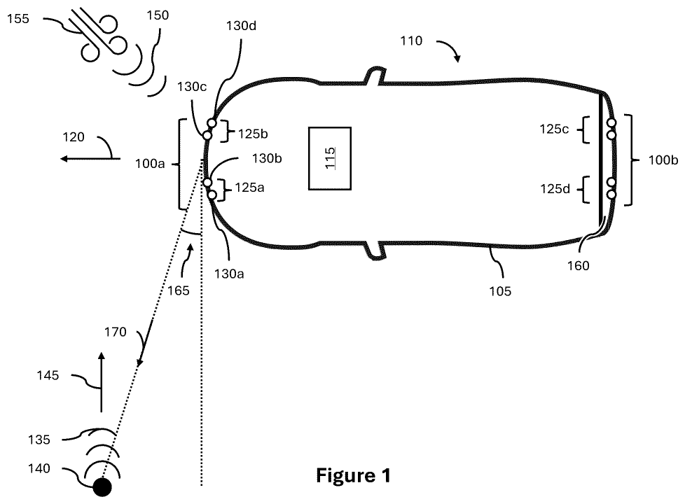

In the following description of FIGS. 1-15, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

An acoustic sensor array and method of processing acoustic data collected by the same are disclosed. The acoustic sensor array includes at least two pairs of acoustic sensors, where each acoustic sensor is disposed a specific distance from the other acoustic sensors of the acoustic sensor array. Advantageously, the specific spacing of the acoustic sensors allows the acoustic sensor array to collect pairs of acoustic data that have high coherence (i.e., are correlated) relative to an acoustic wave of interest. Further, the disclosed method determines pairs of acoustic data that have low coherence (i.e., are uncorrelated) relative to noise. The high-coherence characteristics may be capitalized on to locate a source of interest, such as a siren, emitting the acoustic wave of interest. The low-coherence characteristics may be capitalized on to attenuate the noise within and thereby increase the signal-to-noise ratio (SNR) of the acoustic data using the disclosed method. Other advantages of the acoustic sensor array and disclosed method are described below.

Noise may be especially present within the acoustic data when the acoustic sensor array is disposed on a body of a vehicle. However, it may be advantageous to dispose the acoustic sensor array onto the body of the vehicle so that the acoustic sensor array can be used to detect acoustic changes associated with the environment the vehicle is operating within. In other words, the vehicle can “hear” its surroundings using the acoustic sensor array. This may be especially advantageous for autonomous vehicles that could benefit from siren/alarm detection systems. Accordingly, the acoustic sensor array may be considered part of a siren/alarm detection system.

FIG. 1 depicts acoustic sensor arrays 100a, b disposed on a body 105 of a vehicle 110 in accordance with one or more embodiments. The vehicle 110 includes a body 105, motor 115, and one or more acoustic sensor arrays 100a, b. The motor 115 may be disposed within the vehicle 110 and configured to propel the body 105 along a direction of vehicle travel 120. To do so, though not shown, the vehicle 110 may further include a steering wheel and wheels. Accordingly, the motor 115 may propel the body 105 by rotating the wheels where the steering wheel directs the direction of the wheels along the direction of vehicle travel 120. Though FIG. 1 illustrates the vehicle 110 traveling forward, the vehicle 110 may be traveling in any direction (e.g., backwards) or stopped (e.g., parked or idle) without departing from the scope of the disclosure.

In FIG. 1, the front of the body 105 is oriented to the left. The back of the body 105 is oriented to the right. Each acoustic sensor array 100a, b includes at least two pairs of acoustic sensors 125a-d. Accordingly, in some embodiments, FIG. 1 may illustrate one acoustic sensor array 100a, b that includes four pairs of acoustic sensors 125a-d and, thus, eight acoustic sensors 130a-d. In these embodiments, a first portion of the acoustic sensor array 100a, b may be disposed on the front of the body 105 (e.g., the first and second pairs of acoustic sensors 125a, b) while a second portion of the acoustic sensor array 100a, b may be disposed on the back of the body 105 (e.g., the third and fourth pairs of acoustic sensors 125c, d). In other embodiments, FIG. 1 may illustrate two acoustic sensor arrays 100a, b, where each acoustic sensor array 100a, b includes two pairs of acoustic sensors 125a-d. In these embodiments, one acoustic sensor array 100a may be disposed on the front of the body 105 and one acoustic sensor array 100b may be disposed on the back of the body 105. Hereinafter, two acoustic sensor arrays 100a, b will be considered disposed on the body 105 of the vehicle 110 illustrated in FIG. 1.

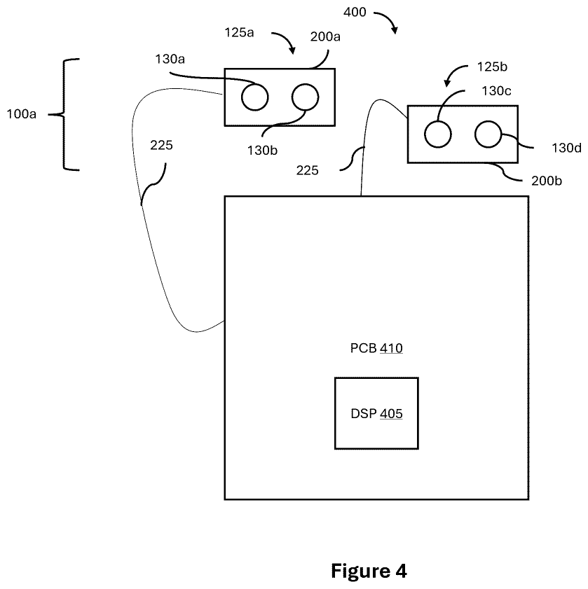

For illustration purposes only, each of the two acoustic sensor arrays 100a, b are shown as two pairs of acoustic sensors 125a-d in FIG. 1. However, each acoustic sensor array 100a, b may include additional elements not shown in FIG. 1. These additional elements are shown in and described relative to FIGS. 4-6 below.

Referring to the acoustic sensor array 100a disposed on the front of the body 105 in FIG. 1, the first pair of acoustic sensors 125a includes a first acoustic sensor 130a and second acoustic sensor 130b. The second pair of acoustic sensors 125b includes a third acoustic sensor 130c and fourth acoustic sensor 130d. However, as noted above, each of the acoustic sensor arrays 100a, b may include two or more pairs of acoustic sensors 125a-d without departing from the scope of the disclosure. In other words, each acoustic sensor array 100a, b may include four, six, eight, ten, etc. acoustic sensors 130a-d.

Each acoustic sensor 130a-d may be omnidirectional. That is, each acoustic sensor 130a-d may be similarly sensitive to, and similarly detect, an acoustic wave propagating in any direction relative to the acoustic sensor 130a-d no matter the orientation of each acoustic sensor 130a-d. Accordingly, each acoustic sensor 130a-d may be or include, without limitation, a standard microphone, piezoelectric sensor, microelectromechanical system (MEMS), condenser microphone, or any other acoustic sensor configured to detect the acoustic wave and convert the acoustic wave to acoustic data. While each type of acoustic sensor 130a-d may uniquely detect the acoustic wave and convert the acoustic wave to acoustic data in the form of an electrical signal, a MEMS may be particularly well suited for use in the acoustic sensor array 100a, b as MEMS are compact and deliver high audio quality. To do so, in some embodiments, MEMS may rely on a transducer in the form of a membrane that moves in response to the acoustic wave. In turn, movement of the transducer alters its capacitance thereby converting the acoustic wave to acoustic data in the form of an electrical signal. In other embodiments, an acoustic wave may alter the resistance of the MEMS by deforming a cantilever thereby converting the acoustic wave to acoustic data in the form of an electrical signal.

Turning to the environment the vehicle 110 is operating within, an acoustic wave of interest 135 may be emitting from a source of interest 140. In some embodiments, the source of interest 140 may be a siren fixed to an emergency service vehicle, such as a police car, ambulance, telemedicine vehicle, or firetruck. Accordingly, in these embodiments, the source of interest 140 may be traveling along a direction of source travel 145 or be stopped (e.g., parked or idle). Though FIG. 1 illustrates the source of interest 140 traveling perpendicular to the vehicle 110, in other embodiments, the source of interest 140 may be traveling in any direction relative to the vehicle 110 without departing from the scope of the disclosure. In other embodiments, the source of interest 140 may be an alarm fixed to a civil engineering structure, such as a stationary civil defense alarm or natural disaster alarm. Accordingly, in still other embodiments, the source of interest 140 may be stationary and not traveling.

Though the acoustic sensor array 100a, b may detect the acoustic wave of interest 135, the acoustic sensor array 100a, b may additionally and simultaneously detect noise 150. For example, as illustrated in FIG. 1, each acoustic sensor array 100a, b may detect both the acoustic wave of interest 135 emitting from the source of interest 140 and noise 150 emitting from wind 155. In some embodiments, the noise 150 may be emitting from various types of weather or other natural disturbances. In other embodiments, the noise 150 may be emitting from manmade disturbances, such as the motor 115 of the vehicle 110, tires of the vehicle 110, general traffic, and construction. In any of these embodiments, the noise 150, in the form of an acoustic wave, may have reflected and/or refracted. Reflected/refracted acoustic waves may be referred to as “multipaths,” which may be noise 150 and/or acoustic waves of interest 135 that have, for example, reflected off surrounding buildings or vehicles or refracted through windows. Hereinafter, the term “acoustic wave” denotes an acoustic wave that includes, but is not necessarily limited to, an acoustic wave of interest 135 emitted from a source of interest 140.

To passively attenuate (i.e., mitigate or filter) the intensity of the noise 150 the acoustic sensor array 100a, b may detect, each acoustic sensor array 100a, b may be disposed on and recessed, in part, within a barrier 160 of the body 105 of the vehicle 110. The barrier 160 may be or include a bumper, side mirrors, and roof of the vehicle 110. However, the barrier 160 may be any wall-like structure that blocks, in part, noise 150 from propagating to and being detected by each acoustic sensor array 100a, b. Such passive noise mitigation may only minimally attenuate the intensity of the noise 150 each acoustic sensor array 100a, b detects while increasing the package depth of each acoustic sensor array 100a, b.

Returning to the vehicle 110 of FIG. 1, in some embodiments, the vehicle 110 may be an autonomous or semi-autonomous vehicle. Hereinafter, the term “autonomous” is used to describe either a fully autonomous or semi-autonomous vehicle. Advantageously, it may be an improvement for the autonomous vehicle to detect an acoustic wave of interest 135 emitting from a source of interest 140, process acoustic data that the acoustic wave of interest 135 is converted into, and react to the source of interest 140 as autonomous vehicles may not be able to detect acoustic waves that are off the grid. For example, it may be useful for the autonomous vehicle to detect an acoustic wave of interest 135 emitting from a siren fixed to a police car (i.e., the source of interest 140), convert the acoustic wave of interest 135 to acoustic data, process the acoustic data, and react by stopping (i.e., auto-braking) the autonomous vehicle to avoid a collision between the autonomous vehicle and police car. For the autonomous vehicle to react appropriately, the autonomous vehicle may need to determine the angle of arrival 165 (AOA) and/or direction of arrival 170 (DOA) of the source of interest 140 (i.e., localize the source of interest 140). Accordingly, the AOA 165 and/or DOA 170 may be used to determine the current location of the source of interest 140 such that the autonomous vehicle may determine a reaction plan. In some embodiments, the reaction plan may include stopping the autonomous vehicle to allow an emergency service vehicle that the source of interest 140 is fixed to pass the autonomous vehicle and, thus, not collide with the autonomous vehicle. In other embodiments, the reaction plan may include adjusting the route of the autonomous vehicle to avoid an emergency service vehicle that the source of interest 140 is fixed to. In still other embodiments, the reaction plan may include adjusting the route of the autonomous vehicle to follow the emergency service vehicle that the source of interest 140 is fixed to in order to aid the emergency service vehicle. In yet still other embodiments, the reaction plan may include alerting a user of the autonomous vehicle that an emergency service vehicle is approaching such that the user may manually react. In some embodiments, the user may be alerted in the form of a visual display (e.g., on a graphical user interface (GUI)) or haptic feedback. In these embodiments, for example, the user may be hearing impaired and require deaf accessibility solutions. Such reaction plans may be particularly useful in cities where there are obstacles, such as buildings, that obstruct a user of an autonomous vehicle from visually seeing the source of interest 140 that is emitting the acoustic wave of interest 135. However, a person of ordinary skill in the art will appreciate that these reaction plans are not an exhaustive list.

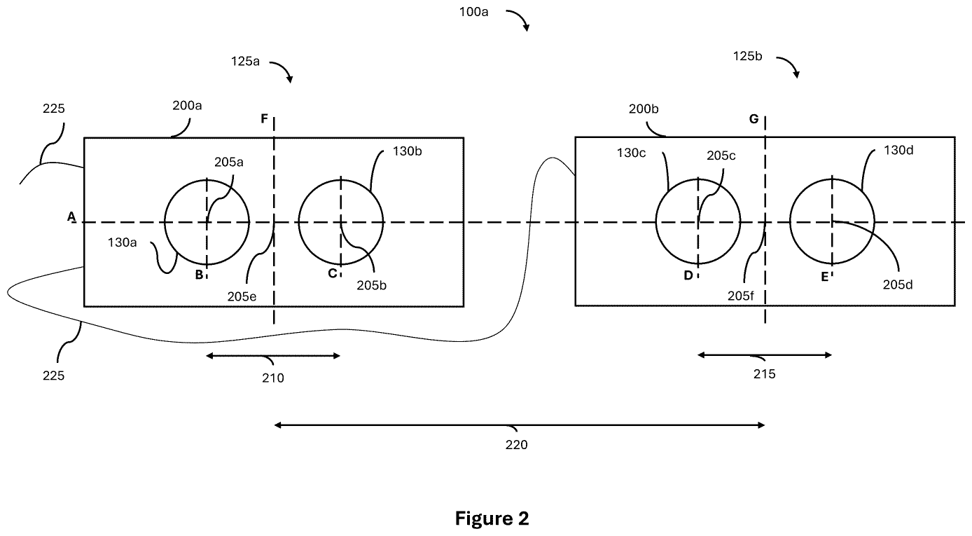

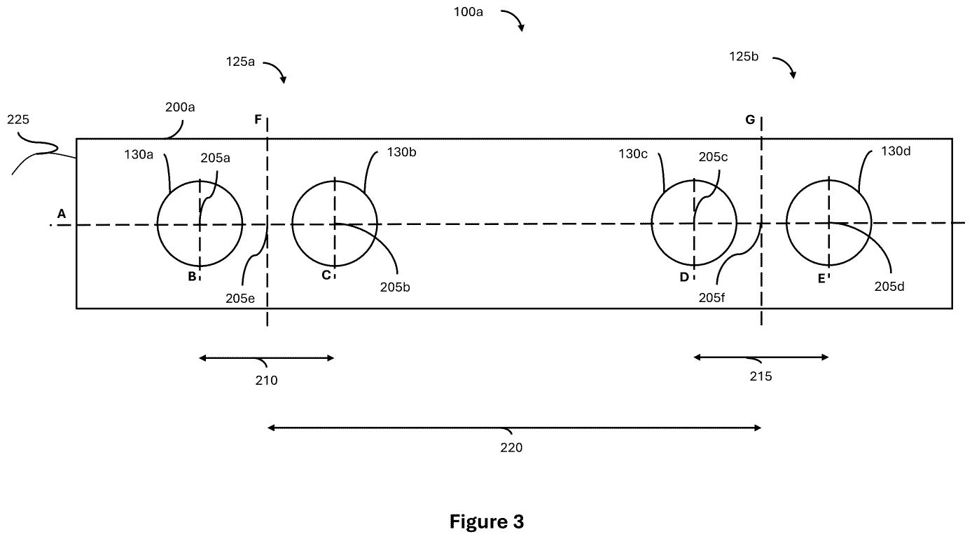

FIGS. 2 and 3 depict an acoustic sensor array 100a in accordance with one or more embodiments. In these embodiments, the acoustic sensor array 100a includes two pairs of acoustic sensors 125a, b. The first pair of acoustic sensors 125a includes a first acoustic sensor 130a and second acoustic sensor 130b. The second pair of acoustic sensors 125b includes a third acoustic sensor 130c and fourth acoustic sensor 130d.

Turning to FIG. 2, in some embodiments, the first pair of acoustic sensors 125a is disposed in a first housing 200a and the second pair of acoustic sensors 125b is disposed in a second housing 200b. The first and second housings 200a, b are disposed adjacent to one another. In practice, each housing 200a, b may be referred to as a capsule, omnidirectional capsule, dual capsule, or dual capsule Automotive Audio Bus® (A²B) slave sensor. Advantageously, separate housings 200a, b for each pair of acoustic sensors 125a, b may allow for flexible placement of the pairs of acoustic sensors 125a, b relative to one another. Further, like a barrier 160, each housing 200a, b may passively attenuate noise 150. However, separate housings 200a, b may not be cost effective.

The first acoustic sensor 130a has a first center 205a as shown by the intersection of lines A and B. The second acoustic sensor 130b has a second center 205b as shown by the intersection of lines A and C. The third acoustic sensor 130c has a third center 205c as shown by the intersection of lines A and D. The fourth acoustic sensor 130d has a fourth center 205d as shown by the intersection of lines A and E. The first and second centers 205a, b are horizontally offset by a first distance 210 (i.e., first intracapsular spacing). In some embodiments, the first distance 210 is between 10 to 75 millimeters (mm), inclusive. In other embodiments, the first distance 210 is between 20 to 40 mm, inclusive. In still other embodiments, the first distance 210 is between 20 to 25 mm, inclusive. In yet still other embodiments, the first distance 210 is based, in part, on the wavelengths of the acoustic wave. For example, the first distance 210 may be small relative to the wavelengths of the acoustic wave the first and second acoustic sensors 130a, b aim to detect. The third and fourth centers 205c, d are horizontally offset by a second distance 215 (i.e., second intracapsular spacing). In some embodiments, the second distance 215 is between 10 to 75 mm, inclusive. In other embodiments, the second distance 215 is between 20 to 40 mm, inclusive. In still other embodiments, the second distance 215 is between 20 to 25 mm, inclusive. In yet still other embodiments, the second distance 215 is based, in part, on the wavelengths of the acoustic wave. For example, the second distance 215 may be small relative to the wavelengths of the acoustic wave the third and fourth acoustic sensors 130c, d aim to detect. The value selected as the first distance 210 need not be the same value selected as the second distance 215 though illustrated as such in FIG. 2. For example, the first center 205a may be located 20 mm from the second center 205b while the third center 205c may be located 35 mm from the fourth center 205d. However, it may be advantageous for the selected values to be the same value to ensure first intermediate acoustic data and second intermediate acoustic data, as described below, have low coherence relative to noise while retaining high coherence relative to the acoustic wave of interest. In turn, the disclosed method may attenuate the low-coherence noise better than the disclosed method would if the selected values are different values.

Though not illustrated in FIG. 2, the first and second acoustic sensors 130a, b may be vertically offset (i.e., disposed in separate horizontal planes) relative to one another as may the third and fourth acoustic sensors 130c, d relative to one another. Accordingly, the first acoustic sensor 130a may be disposed above or below the second acoustic sensor 130b and/or the third acoustic sensor 130c may be disposed above or below the fourth acoustic sensor 130d. Further, though not illustrated in FIG. 2, the first and second pairs of acoustic sensors 125a, b may be vertically offset relative to one another. Accordingly, the first pair of acoustic sensors 125a may be disposed above or below the second pair of acoustic sensors 125b. To do so, in some embodiments, the first pair of acoustic sensors 125a may be vertically offset within the first housing 200a and/or the second pair of acoustic sensors 125b vertically offset within the second housing 200b. In other embodiments, the first housing 200a may be vertically offset relative to the second housing 200b such that the first pair of acoustic sensors 125a are disposed above or below the second pair of acoustic sensors 125b.

How the acoustic sensors 130a-d are disposed relative to one another may offer advantages or disadvantages that may depend on the direction of source travel 145 of the source of interest 140. For example, it may be disadvantageous to dispose the acoustic sensors 130a-d in two or more horizontal planes when the azimuth of the source of interest 140 is changing over time. Doing so may reduce the ability of the disclosed method to be used to locate the source of interest 140 when the acoustic sensor array 100a is disposed on a body 105 of a vehicle 110. That is, the disclosed method may be unable to locate azimuth changes in the source of interest 140 over time. Accordingly, it may be advantageous to dispose the acoustic sensors 130a-d in a single horizontal plane to locate an azimuthally-changing source of interest 140 over time. In another example, it may be advantageous to dispose the acoustic sensors 130a-d in two or more horizontal planes when the altitude of the source of interest 140 is changing over time, such as if the source of interest 140 is disposed on a drone.

The first pair of acoustic sensors 125a has a fifth center 205e as shown by the intersection of lines A and F. The second pair of acoustic sensors 125b has a sixth center 205f as shown by the intersection of lines A and G. The fifth and sixth centers 205e, f are horizontally offset by a third distance 220 (i.e., intercapsular spacing). In some embodiments, the third distance 220 is between 75 to 400 mm, inclusive. In other embodiments, the third distance 220 is between 100 to 200 mm, inclusive.

Further, in some embodiments, one or more wires 225 may be connected to each acoustic sensor 130a-d though FIG. 2 illustrates the one or more wires 225 connected to each housing 200a, b. The wiring configuration and types of wires 225 are further discussed in relation to FIGS. 4-6.

FIG. 3 illustrates the first pair of acoustic sensors 125a and second pair of acoustic sensors 125b as illustrated in FIG. 2. However, now both pairs of acoustic sensors 125a, b are disposed in a first housing 200a. Though not illustrated in either of FIGS. 2 and 3, each housing 200a, b may be a curved housing such that the each housing 200a, b follows a curvature of a body 105 or barrier 160 of a vehicle 110 the acoustic sensor array 100a is disposed on and recessed within. In practice, the first housing 200a may be referred to as a capsule, omnidirectional capsule, quad capsule, or quad capsule A²B slave sensor. Advantageously, one housing 200a for the two pairs of acoustic sensors 125a, b may be cost effective, allow for simpler wiring, and reduce processing expense. Specifically, processing expense may be reduced when the one housing 200a includes an onboard digital signal processor (DSP) and onboard printed circuit board (PCB) neither of which is shown in FIG. 3 but are discussed relative to FIGS. 4-6.

FIGS. 4-6 depict a system 400 in accordance with one or more embodiments. In these embodiments, the system 400 includes an acoustic sensor array 100a as described relative to FIGS. 2 and 3, DSP 405, and PCB 410. However, in other embodiments, the acoustic sensor array 100a may include additional pairs of acoustic sensors 125a, b and/or the system 400 may include additional DSPs 405, additional PCBs 410, and/or standard electrical components without departing from the scope of the disclosure. Standard electrical components may include capacitors, resistors, integrated circuits (ICs), analog-to-digital (A/D) converters, memory, etc.

The PCB 410 may be configured to communicably couple the acoustic sensor array 100a and DSP 405 to one another. To so do, in some embodiments, the acoustic sensor array 100a and DSP 405 may be fixed to the PCB 410. In some embodiments, each pair of acoustic sensors 125a, b may be directly fixed to the PCB 410 via a wire 225 as illustrated in FIG. 4. Each wire 225 may be an A²B cable. Each wire 225 may be fixed to the PCB 410 using solder. Further, each wire 225 may be fixed to any pair of acoustic sensors 125a, b using solder or by clamping an end of the wire 225 to a clip or connector (e.g., port) associated with any pair of acoustic sensors 125a, b (i.e., by wire harness). The DSP 405 may be directly fixed to the PCB 410 using solder. Accordingly, the system 400 may be referred to as a printed circuit board assembly (PCBA).

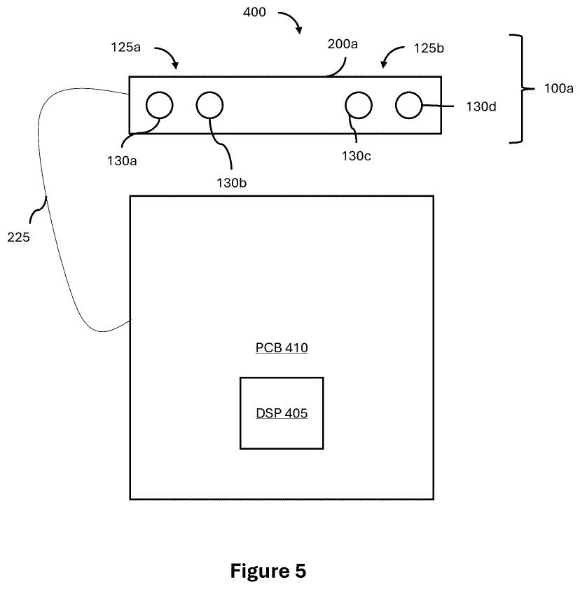

In other embodiments, as illustrated in FIG. 5, the acoustic sensor array 100a disposed in a single housing 200a may be directly and collectively fixed to the PCB 410 via a wire 225.

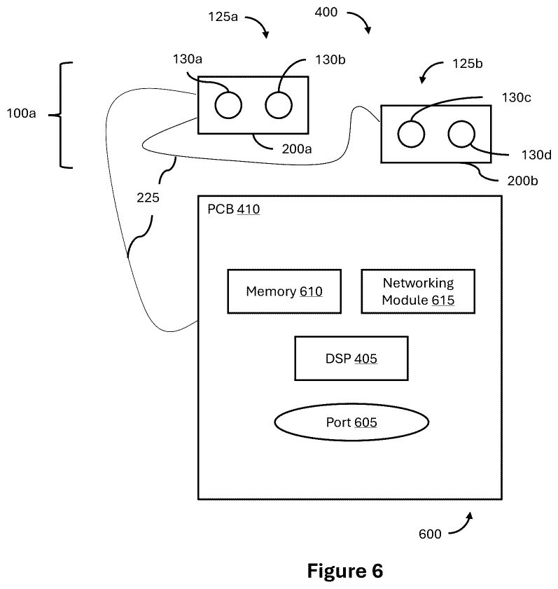

In still other embodiments, as illustrated in FIG. 6, the pairs of acoustic sensors 125a, b in separate housings 200a, b may be daisy-chained where, for example, the second pair of acoustic sensors 125b is directly fixed to the first pair of acoustic sensors 125a via a first wire 225 and the first pair of acoustic sensors 125a is directly fixed to the PCB 410 via a second wire 225.

In some embodiments, the system 400 may include a computing device 600. In some embodiments, the computing device 600 may include the PCB 410 and DSP 405 as well as a port 605, memory 610, and networking module 615. In some embodiments, these additional standard electrical components may be fixed to the PCB 410 using solder. The computing device 600 may take the form of a smart phone, tablet, desktop computer, laptop, electronic control unit (ECU) of a vehicle 110, smart acoustic sensor array (described below), or equivalent devices as will be appreciated by a person having ordinary skill in the art.

The computing device 600 may include a port 605. The port 605 may be configured to transfer any data stored in the memory 610 of the computing device 600 to another device. In some embodiments, the port 605 may be a universal serial bus (USB) port configured to receive a USB cable connected to portable memory 610 or portable flash drive that includes portable memory 610.

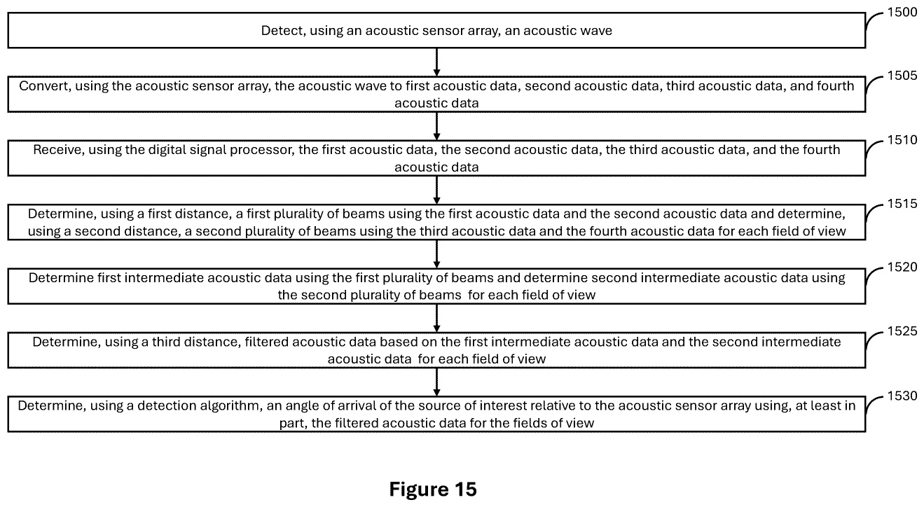

The computing device 600 may include a memory 610. The memory 610 stores instructions in the form of computer-readable code that the DSP 405 may execute. For example, the memory 610 may store computer-readable code used to execute the disclosed method as described relative to FIG. 15. Further, the memory 610 may store drivers for the acoustic sensor array 100a. Still further, the memory 610 may store the acoustic data collected by the acoustic sensor array 100a as well as processed acoustic data determined by the disclosed method.

The DSP 405 is configured to execute the computer-readable code stored on the memory 610. The DSP 405 may include one or more processors, integrated circuits, microprocessors, or equivalent computing structures configured to execute the computer-readable code stored on the memory 610. The computer-readable code executed by the DSP 405 may perform general computing functions as well as the disclosed method. For example, the DSP 405 may store additional computer-readable code that allows the computing device 600 to interface with other devices, such as drivers for peripheral devices (e.g., an acoustic sensor array 100a, monitor, or haptic feedback system). The DSP 405 may further execute computer-readable code that displays a GUI on, for example, a monitor. The GUI may alert the user of a vehicle 110 the acoustic sensor array 100a is disposed on that a nearby source of interest 140 is emitting an acoustic wave of interest 135. Further, the GUI may display a map to show the user where the source of interest 140 is relative to the vehicle 110 the user is operating. Still further, the DSP 405 may execute computer-readable code that allows a user or system engineer to adjust parameters associated with the system 400 and/or disclosed method.

The networking module 615 of the computing device 600 may be configured to transmit processed acoustic data to other devices. In some embodiments, the networking module 615 may include a Bluetooth chip. In other embodiments, the networking module 615 may include a wireless network card configured to transmit the processed acoustic data to another computing device or a server, for example. In still other embodiments, the networking module 615 may be embodied as one or more wired networking connections such as a Local Area Network (LAN) port or Ethernet port.

Though FIGS. 4-6 illustrate the acoustic sensor array 100a, DSP 405, and PCB 410 as separate elements of the system 400, in other embodiments, the acoustic sensor array 100a may include an onboard DSP 405, onboard PCB 410, and/or other onboard standard electrical components. Such a configuration may be referred to as a “smart acoustic sensor array.”

Turning to the function of the system 400, each acoustic sensor 130a-d of the acoustic sensor array 100a detects an acoustic wave. As described relative to FIG. 1, the acoustic wave may include an acoustic wave of interest 135 emitting from a source of interest 140 and noise 150. Each acoustic sensor 130a-d may convert the acoustic wave to acoustic data. Specifically, the first acoustic sensor 130a is configured to convert the acoustic wave to first acoustic data. The second acoustic sensor 130b is configured to convert the acoustic wave to second acoustic data. The third acoustic sensor 130c is configured to convert the acoustic wave to third acoustic data. The fourth acoustic sensor 130d is configured to convert the acoustic wave to fourth acoustic data.

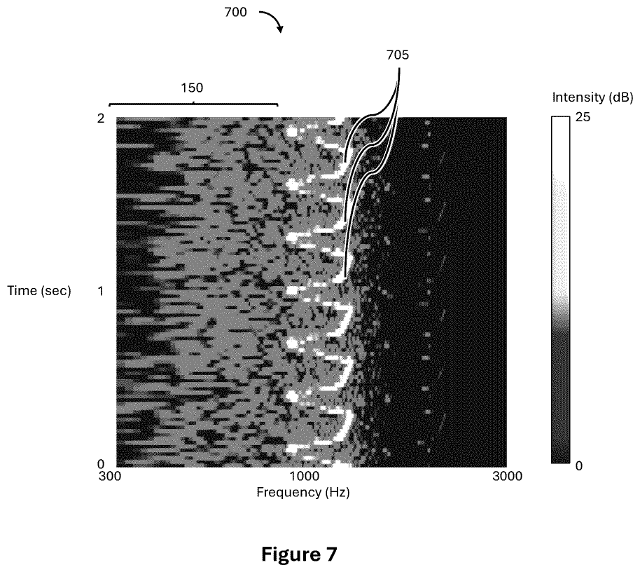

FIG. 7 displays acoustic data 700 in accordance with one or more embodiments. The acoustic data 700 may be first, second, third, or fourth acoustic data. Accordingly, FIG. 7 is used for illustration purposes only and is not meant to limit the present disclosure. Hereinafter, one or more of the first through fourth acoustic data and/or processed acoustic data may be generically referred to as simply “acoustic data.” Note the acoustic data 700 may also be referred to as an acoustic signal though not used throughout this disclosure. FIG. 7 displays the acoustic data 700 in the form of a spectrogram. Time in seconds (sec) is displayed along the vertical axis or ordinate. Frequency in hertz (Hz) is displayed along the horizontal axis or abscissa. Intensity in decibels (dB) is displayed in grayscale. A person of ordinary skill in the art will appreciate that intensity may alternatively be displayed as an amplitude and/or referred to as an energy in the art of acoustics.

In some embodiments, the acoustic data 700 (or derivations thereof) may have a frequency range or may be filtered to include acoustic data 700 within a certain frequency range (i.e., bandwidth). The frequency range selected may be based, in part, on the frequency range of the acoustic wave of interest 135, the spatial aliasing frequency limit (dictated by the third distance 220), and/or the frequency of self-generated noise of the acoustic sensor array 100a, b. In some embodiments, a low-pass filter may be applied to the acoustic data 700 to mitigate spatial aliasing. In some embodiments, a high-pass filter may be applied to the acoustic data 700 to attenuate self-generated, low-frequency noise of the acoustic sensor array 100a, b, particularly when differential beamforming is used as a part of the disclosed method as described below. Though FIG. 7 displays the acoustic data 700 between approximately 300 Hz and 3 kHz (i.e., the cutoff frequencies), any low-pass filter and/or high-pass filter with any cutoff frequency may be used without departing from the scope of the disclosure.

The acoustic data 700 includes a manifestation of an acoustic wave of interest 705. In some embodiments, the acoustic data 700 further includes noise 150. The noise 150 may be mixed, in part, with the manifestation of the acoustic wave of interest 705. Though the manifestation of the acoustic wave of interest 705 within the acoustic data 700 may have a higher intensity than the noise 150 as shown by the grayscale. Further, the manifestation of the acoustic wave of interest 705 may be periodic in nature as shown in FIG. 7.

Because each acoustic sensor 130a-d of the acoustic sensor array 100a is disposed at a different position relative to the other acoustic sensors 130a-d, each acoustic sensor 130a-d detects the acoustic wave of interest 135 at a unique phase and intensity. Accordingly, the first through fourth acoustic data initially have phase diversity relative to one another.

Useful coherence characteristics may exist within the acoustic data 700 due to the spacing of the acoustic sensors 130a-d within the acoustic sensor array 100a. Here, coherence is a measure of a linear relationship between pairs of acoustic data in the frequency domain, which may range between zero and one, inclusive, for each frequency. For example, because the first distance 210 between the first and second acoustic sensors 130a, b is relatively small, the first and second acoustic data have high coherence relative to the manifestation of the acoustic wave of interest 705 and noise 150. Further, because the second distance 215 between the third and fourth acoustic sensors 130c, d is relatively small, the third and fourth acoustic data have high coherence relative to the manifestation of the acoustic wave of interest 705 and noise 150. In some embodiments, high coherence may be above 0.7 and low coherence below 0.3 while values between 0.3 and 0.7 may be uncertain.

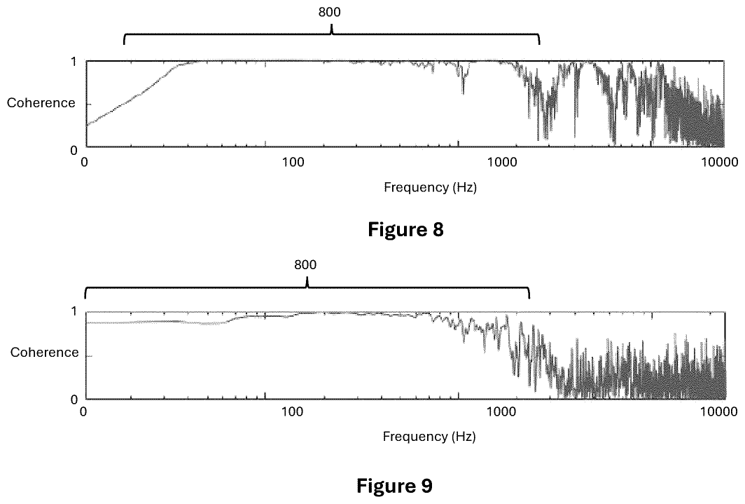

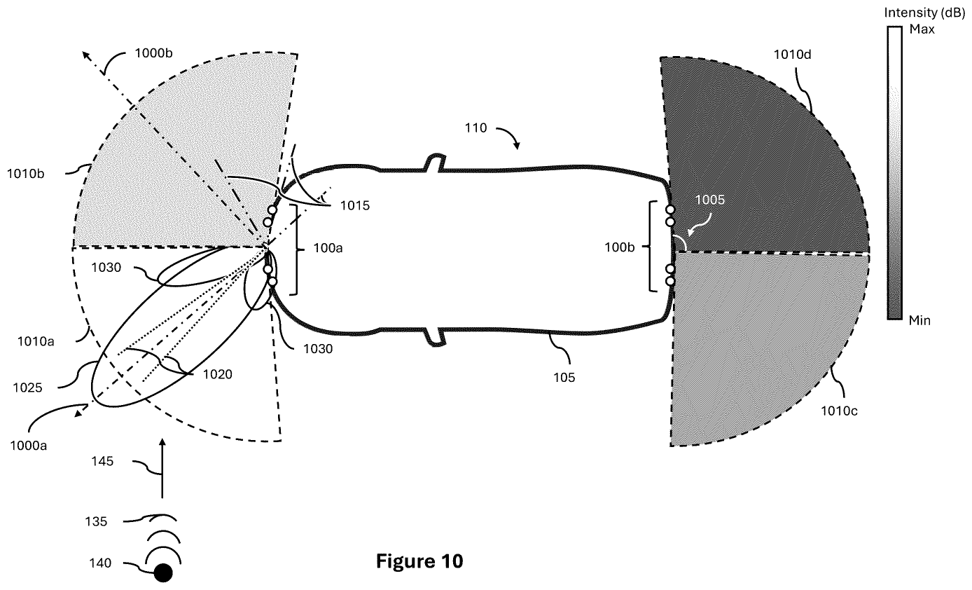

FIGS. 8 and 9 display coherence in accordance with one or more embodiments. Coherence is shown along the vertical axis or ordinate. Frequency in Hz is shown along the horizontal axis or abscissa. Specifically, FIG. 9 displays a frequency range with high coherence 800 relative to the manifestation of the acoustic wave of interest 705 when a pair of acoustic sensors 125a are stationary. In juxtaposition, FIG. 10 displays a frequency range with high coherence 800 relative to the manifestation of the acoustic wave of interest 705 when the pair of acoustic sensors 125 a are traveling at 50 kilometers per hour (kph), a speed the pair of acoustic sensors 125a might experience when disposed on a body 105 of a vehicle 110.

Though it may be advantageous to dispose the acoustic sensor array 100a onto the body 105 of the vehicle 110 such that the vehicle 110 can detect acoustic changes its surroundings using the acoustic sensor array 100a, such a configuration poses processing challenges due to noise. That is, traditional (i.e., classical) AOA methods used to locate the source of interest 140 may be unsuitable.

In brief, traditional AOA methods may exploit the phase diversity within the first through fourth acoustic data 700 to locate the source of interest 140. Traditional AOA methods may include, without limitation, generalized cross-correlation phase transform (GCC-PHAT), steered-response power phase transform (SRP-PHAT), and multiple signal classification (MUSIC). However, traditional AOA methods may only be effective if the noise 150 detected by the acoustic sensor array 100a is below a suitable threshold or attenuated as a part of pre-processing. Traditional noise attenuation methods may include multiple input single output (MISO) approaches and non-MISO approaches. MISO approaches may include, without limitation, beamforming (using one or more beamformers), beam steering, multi-beam, multi-band (using one or more bandpass filters), and combinations thereof. Beamforming may include, without limitation, differential beamforming (including first-order differential beamforming) and delay-and-sum beamforming. In brief, multi-beam may use multiple beamformers. Each beamformer determines a beam using acoustic data 700 collected from two or more acoustic sensors 130a-d, where the energy out of each beam is measured for each time sample. The beam with the lowest energy at the current time sample is crossfaded with the previously-selected beam for all time samples to determine a mixed beam. The mixed beam contains lower noise 150 compared to the any of the individual beams that are used to determine the mixed beam. Multi-band applies multi-beam to each of multiple bandwidths within the acoustic data 700.

MISO approaches may substantially suppress uncorrelated signals (e.g., noise 150) while substantially retaining correlated signals (e.g., a manifestation of the acoustic wave of interest 705) especially in a “look” direction, which is described below. For example, delay-and-sum beamforming may reduce uncorrelated signals by a maximum of 10log(N) dB, where N is the number of acoustic sensors 130a-d. Further, multi-beam may attenuate peak-impulse disturbances. Still further, multi-beam may attenuate ambient noise 150 outside of a field of view (FOV), also described below. Though MISO approaches may adequately attenuate the noise 150 within and thereby increase the SNR of the acoustic data 700 in the “look” direction, MISO approaches do so at the cost of destroying phase diversity (as there is only a single output) thereby rendering the use of traditional AOA methods ineffective.

Non-MISO approaches may include noise suppression filters and adaptive filtering techniques. Non-MISO approaches may not be useful for a distant source of interest 140, provide poor spectrum estimation, attenuate the manifestation of the acoustic wave of interest 705 with the noise 150, and degrade the accuracy of the original phase diversity detected across the acoustic sensors 130a-d of the acoustic sensor array 100a (in favor of lowering the noise floor). Accordingly, use of a traditional AOA method following use of a non-MISO approach would also be ineffective by reducing a detection range in favor of increasing AOA accuracy.

As a result of the above, an untraditional AOA method that exploits a feature other than phase diversity may be needed. Advantageously, the disclosed method attenuates noise (by capitalizing on the coherence characteristics associated with the acoustic sensor array 100a) and determines filtered acoustic data with intensity diversity. Accordingly, an untraditional AOA method may exploit this intensity diversity (in place of phase diversity traditional AOA methods exploit) to locate the source of interest.

FIG. 10 illustrates some of the features associated with the disclosed method. These features are illustrated relative two acoustic sensor arrays 100a, b disposed on the body 105 of the vehicle 110 as previously described relative to FIG. 1. In one aspect, FIG. 10 illustrates “look” directions 1000a, b. Each “look” direction 1000a, b may be referred to as a steering direction or beam direction. Further, each “look” direction 1000a, b may be defined by a predetermined design angle (not shown). Each “look” direction 1000a, b and predetermined aperture 1005 define each FOV 1010a-d. For example, in reference to the first acoustic sensor array 100a in FIG. 10, a first “look” direction 1000a is somewhat directed towards the source of interest 140. Further, the predetermined aperture 1005 is about 90 degrees. Accordingly, the first FOV 1010a fans out and is centered around the first “look” direction 1000a based on the predetermined aperture 1005. The second “look” direction 1000b is somewhat directed away from the source of interest 140. Accordingly, the second FOV 1010b fans out and is centered around the second “look” direction 1000b based on the predetermined aperture 1005.

To perform the disclosed method, two or more “look” directions 1000a, b are defined for each acoustic sensor array 100a, b as illustrated in FIG. 10. Accordingly, two or more FOVs 1010 a-d are defined for each acoustic sensor array 100a, b also illustrated in FIG. 10. That is, in some embodiments, the first acoustic sensor array 100a is associated with the first and second FOVs 1010a, b while the second acoustic sensor array 100b is associated with the third and fourth FOVs 1010c, d. In other embodiments, more than two FOVs 1010a-d may be associated with each acoustic sensor array 100a, b. In these embodiments, the predetermined aperture 1005 may be decreased such that the more than two FOVs 1010a-d only slightly overlap if at all. For example, if 12 FOVs 1010 a-d are wanted to span in front of the body 105 of the vehicle 110, which may span about 180 degrees, a predetermined aperture 1005 of 15 degrees may be used. Smaller predetermined apertures 1005 and more FOVs 1010a-d may increase the resolution of determining the AOA 165 and/or DOA 170 of the source of interest 140 later.

Note though FIG. 10 illustrates each FOV 1010a-d as a sector of a circle, a person of ordinary skill in the art will appreciate that each FOV 1010a-d also extends vertically into and out of FIG. 10 such that each FOV 1010a-d is cone-like. A person of ordinary skill in the art will also appreciate that each FOV 1010a-d may extend or “reach” further than what is shown in FIG. 10. In other words, the radius of each sector that denotes an FOV 1010a-d may be larger than what is shown in FIG. 10. Accordingly, in some embodiments, neighboring FOVs 1010-a-d may overlap, in part.

In some embodiments, the FOVs 1010a-d inform the design of the beamformers, where the beamformers ultimately determine beams within each FOV 1010a-d. A beamformer (used in beamforming) may be designed to direct the acoustic data 700 towards an FOV 1010a-d while substantially ignoring the acoustic data 700 at unique null angles outside the FOV 1010a-d. In other words, the beamformer may be designed such that the acoustic sensor array 100a, b appears to detect an acoustic wave propagating within or near an FOV 1010a-d while substantially ignoring an acoustic wave propagating outside the FOV 1010a-d (e.g., in other FOVs 1010a-d). For reference, FIG. 10 illustrates a few unique null angles relative to the first “look” direction 1000a, where each unique null angle is the angle between the first “look” direction 1000a and line 1015. However, any number of unique null angles may be used without departing from the scope of the disclosure.

Though “look” direction 1000a, b, predetermined aperture 1005, FOV 1010 a-d, and null angle are described relative to the acoustic sensor array 100a, b disposed on a body 105 of a vehicle 110, these features are not directly associated with the acoustic sensor array 100a, b itself but are associated with the disclosed method. Accordingly, the first through fourth acoustic data 700 collected by the acoustic sensor array 100a, b are not initially associated with FOVs 1010a-d.

Beamforming may be performed as a part of the disclosed method. For example, a first beamformer may be designed for and applied to the first and second acoustic data to determine first beams 1020 (i.e., directional acoustic signals). Directionality is created by delaying the first or second acoustic data based on the first distance 210 between the first and second acoustic sensors 130a, b that collect the first and second acoustic data. Each first beam 1020 includes an intensity (i.e., energy) associated with the acoustic wave at each time sample. The first beams 1020 may form a main lobe 1025. The main lobe 1025 is oriented or directed towards the first “look” direction 1000a and delimited by one or more unique null angles as illustrated in FIG. 10. Accordingly, the first beamformer directs the first beams 1020 towards the first “look” direction 1000a. Other beams may form one or more side lobes 1030 not oriented towards the first “look” direction 1000a. A collection of one or more lobes may be described based on its polar pattern. Polar patterns may include dipole polar patterns, hyper-cardioid polar patterns, cardioid polar patterns, and, generally, null angles placed between 90 and 180 degrees relative to a “look” direction 100a of 0 degrees. Dipole polar patterns may include two opposing main lobes 1025 and two unique null angles. Further, hyper-cardioid polar patterns may include a main lobe 1025 and two unique null angles. Still further, cardioid polar patterns may include a main lobe 1025 and one unique null angle.

Returning to the first beams 1020, the first beams 1020 may have a higher energy than the other beams. Note the first beams 1020 illustrated in FIG. 10 are oriented in a slightly different direction than the first “look” direction 1000a for illustration purposes only. In practice, the first beams 1020 are directed in the same direction as the first “look” direction 1000a.

In some embodiments, the design of the first beamformer may further rely on the first distance 210. The first distance 210 may be used to shift the first or second acoustic data 700 such that the two are substantially in-phase with one another. Any beamformer known to a person of ordinary skill in the art may be used without departing from the scope of the disclosure, such as a differential beamformer, minimum variance distortionless response (MVDR) beamformer, generalized sidelobe canceler (GSC) beamformer, or delay-and-sum beamformer. However, because each beamformer may have a unique topology, each beamformer may shift the first or second acoustic data 700 in a unique way and/or at a unique point in the beamforming process. To account for this, an additional shift may be included in the design of the first beamformer to ensure the first and second acoustic data 700 are substantially in-phase.

Though the first beams 1020 are all associated with the first “look” direction 1000a, each of the first beams 1020 are associated with a unique null angle. For example, each unique null angle may be defined in 60 degree increments relative to the first “look” direction 1000a. That is, one first beam 1020 may have a unique null angle of 60 degrees relative to the first “look” direction 1000a, another first beam 1020 may have a unique null angle of 120 degrees relative to the first “look” direction 1000a, etc. Accordingly, each first beam 1020 substantially or fully ignores an acoustic wave propagating at the associated unique null angle. However, any number of unique null angles as defined by any of one or more increments may be used without departing from the scope of the disclosure.

A second beamformer may be designed for and applied to the third and fourth acoustic data 700 to determine second beams. Though not explicitly shown in FIG. 10, the second beams also form a main lobe oriented towards the first “look” direction 1000a as the first beams 1020 do. The design of the second beamformer may further rely on the second distance 215. The second distance 215 may be used to shift the third or fourth acoustic data 700 such that the two are substantially in-phase with one another. Advantageously, designing the first and second beamformers in the same “look” direction 1000a maintains the strength of the far-field acoustic wave of interest 135 that manifests in each of the first and second beams 1020 for each FOV 1010a-d and exploits differences in noise pickup across the pairs of acoustic sensors 125a, b to thereby improve overall noise suppression.

Though the second beams are all associated with the first “look” direction 1000a, each second beam is associated with one or more unique null angles that each first beam 1020 is associated with. For example, a first beam 1020 and second beam may be associated with the unique null angle of −90 degrees relative to the first “look” direction 1000a, another first beam 1020 and another second beam may be associated with the unique null angle of −120 degrees relative to the first “look” direction 1000a, etc. A first beam 1020 and second beam associated with the same associated unique null angle is hereinafter referred to as a “beam pair.”

Accordingly, the first and second beamformers are designed such that the acoustic sensor array 100a appears to detect an acoustic wave propagating in or near the first FOV 1010a. This process may be repeated using the first through fourth acoustic data 700 for each of the remaining FOVs 1010b-d that are each based on a different “look” direction 1000a, b. In doing so, the first through fourth acoustic data 700 may be processed such that the acoustic sensor array 100a, b appears to detect an acoustic wave within each FOV 1010a-d at a unique intensity. For example, as illustrated in FIG. 10, the first acoustic sensor array 100a may appear to detect the acoustic wave of interest 135 at a high intensity within the first FOV 1010a as illustrated by the white shading of the first FOV 1010a and the intensity scale bar in units of dB. The first acoustic sensor array 100a may appear to detect the acoustic wave of interest 135 at a moderate intensity within the second FOV 1010b as illustrated by the light gray shading of the second FOV 1010b. The second acoustic sensor array 100b may appear to detect the acoustic wave of interest 135 at a low intensity (if at all) within the third and fourth FOVs 1010c, d as illustrated by the moderate and dark gray shading of the third and fourth FOVs 1010c, d. Accordingly, the first acoustic sensor array 100a can detect the acoustic wave of interest 135 at a greater intensity (i.e., better) than the second acoustic sensor array 100b. Thus, intensity diversity within FOVs 1010a-d are determined.

Note the intensity within each FOV 1010a-d depends, in part, on where the source of interest 140 is located. For example, if the source of interest 140 in FIG. 10 was instead located in the bottom righthand corner of the figure, the third and fourth FOVs 1010c, d may have white and light gray shading while the first and second FOVs 1010a, b may have moderate and dark gray shading. In these embodiments, the second acoustic sensor array 100b may appear to detect the acoustic wave of interest 135 at a greater intensity than the first acoustic sensor array 100a.

Returning to the beams, the first beams 1020 may be used to determine first intermediate acoustic data and the second beams may be used to determine second intermediate acoustic data. To do so, in some embodiments, multiplexing (colloquially “muxing”) may be performed. In the context of this disclosure, multiplexing is the process of combining two or more beams into a single beam.

In some embodiments, multiplexing may be performed by selecting a minimum energy on a sample-by-sample basis among the first beams 1020 and crossfading the selected minimum energy for all samples together to determine or generate a first mixed beam (hereinafter denoted the “first intermediate acoustic data”). In doing so, the first mixed beam may contain less energy and, thus, less noise 150 compared to any of the first beams 1020 at each sample. Accordingly, the first mixed beam may have a higher SNR over time compared to any of the first beams 1020 on their own over time. Further, multiplexing may be performed by selecting a minimum energy on a sample-by-sample basis among the second beams and crossfading the second beams with the minimum energy for all samples together to determine or generate a second mixed beam (hereinafter denoted the “second intermediate acoustic data”). In doing so, the second mixed beam contains less noise 150 compared to any of the second beams. Accordingly, the second mixed beam may have a high SNR over time compared to any of the second beams on their own over time.

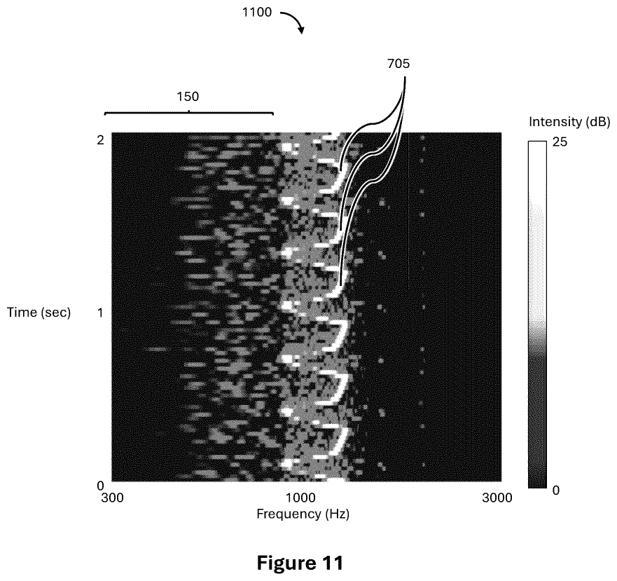

FIG. 11 displays intermediate acoustic data 1100 as a spectrogram in accordance with one or more embodiments. The intermediate acoustic data 1100 may be first or second intermediate acoustic data. Accordingly, FIG. 11 is used for illustration purposes only and is not meant to limit the present disclosure. Upon a comparison of the intermediate acoustic data 1100 with the acoustic data 700 of FIG. 7, noise 150 within the acoustic data 700 is attenuated within the intermediate acoustic data 1100 while maintaining a substantially similar intensity for the manifestation of the acoustic wave of interest 705 (i.e., there is unity gain) to thereby increase the SNR. Accordingly, applying a first beamformer to the first and second acoustic data to determine the first intermediate acoustic data 1100 may result in noise attenuation and an increased SNR in the first intermediate acoustic data 1100 relative to the first and second acoustic data. Further, applying a second beamformer to the third and fourth acoustic data to determine the second intermediate acoustic data may result in noise attenuation and an increased SNR in the second intermediate acoustic data 1100 relative to the third and fourth acoustic data.

Because the third distance 220 between the first and second pairs of acoustic sensors 125a, b is relatively large, the first and second intermediate acoustic data 1100 may have low coherence relative to the noise 150. Accordingly, the noise 150 may be further attenuated by applying a MISO approach to the first and second intermediate acoustic data 1100 to determine filtered acoustic data. In some embodiments, to perform the MISO approach, multiplexing may be performed by selecting a minimum energy on a sample-to-sample basis among the first and second intermediate acoustic data (i.e., the first and second mixed beam) and crossfading the first or second intermediate acoustic data with the minimum energy at each sample together to determine the filtered acoustic data (i.e., mixed beam).

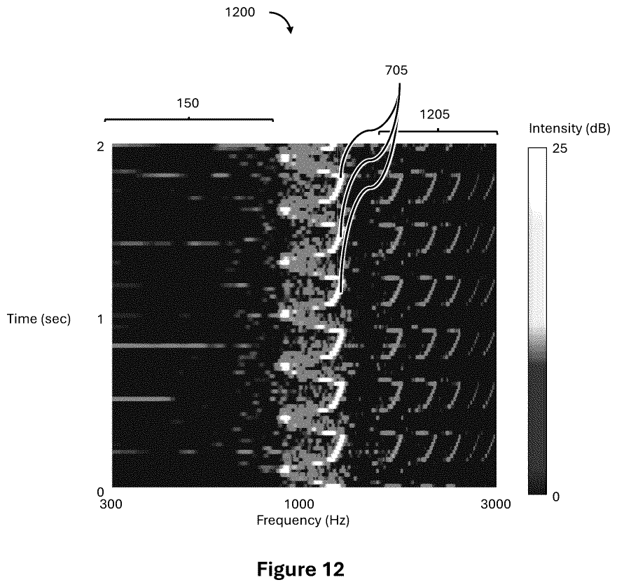

FIG. 12 displays filtered acoustic data 1200 as a spectrogram in accordance with one or more embodiments. Upon a comparison of the filtered acoustic data 1200 with the intermediate acoustic data 1100 of FIG. 11, noise 150 within the intermediate acoustic data 1100 is attenuated within the filtered acoustic data 1200 while maintaining a substantially similar intensity for the manifestation of the acoustic wave of interest 705 to thereby increase the SNR. In some embodiments, the filtered acoustic data 1200 may include harmonics 1205 in the higher frequency range, which may be considered an artifact of the disclosed method.

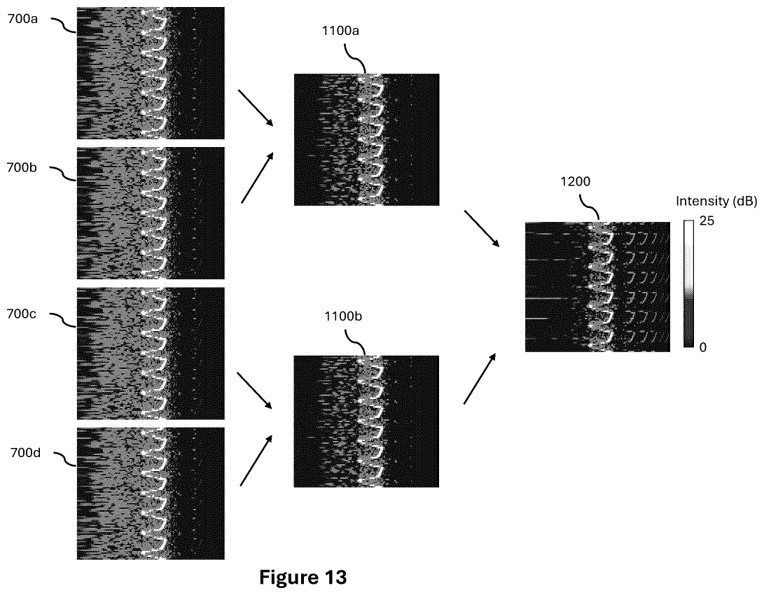

FIG. 13 displays a flowchart in accordance with one or more embodiments. On the left, the first through fourth acoustic data 700a-d are displayed as spectrograms. The first acoustic data 700a is collected by the first acoustic sensor 130a of the acoustic sensor array 100a. The second acoustic data 700b is collected by the second acoustic sensor 130b of the acoustic sensor array 100a. The third acoustic data 700c is collected by the third acoustic sensor 130c of the acoustic sensor array 100a. The fourth acoustic data 700d is collected by the fourth acoustic sensor 130d of the acoustic sensor array 100a.

In some embodiments, a first beamformer may be applied to the first and second acoustic data 700a, b to determine the first intermediate acoustic data 1100a. In some embodiments, a second beamformer may be applied to the third and fourth acoustic data 700c, d to determine the second intermediate acoustic data 1100b.

In some embodiments, a MISO approach may be applied to the first and second intermediate acoustic data 1100a, b to determine the filtered acoustic data 1200.

Upon a comparison, the noise 150 within the first and second acoustic data 700a, b is attenuated within the first intermediate acoustic data 1100a and further attenuated within the filtered acoustic data 1200 to thereby increase the SNR. Further, the noise 150 within the third and fourth acoustic data 700c, d is attenuated within the second intermediate acoustic data 1100b and further attenuated within the filtered acoustic data 1200 to thereby increase the SNR.

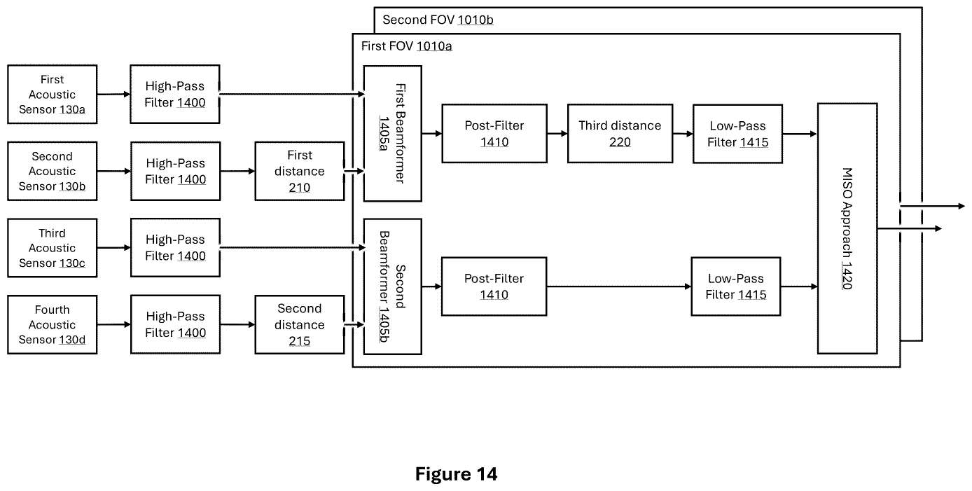

FIG. 14 depicts a block diagram in accordance with one or more embodiments. The block diagram illustrates the disclosed method in accordance with one or more embodiments. As previously described, the first through fourth acoustic sensors 130a-d of the acoustic sensor array 100a, as shown on the far left of FIG. 14, detect an acoustic wave and convert the acoustic wave to first through fourth acoustic data 700a-d.

In some embodiments, a high-pass filter 1400 may be applied to each of the acoustic data 700a-d. Any high-pass filter 1400 known to a person of ordinary skill in the art with any cutoff frequency may be used. However, the cutoff frequency may be based on the bandwidth of the acoustic wave of interest 135 such that the bandwidth of the acoustic wave of interest 135 is maintained once the acoustic data 700a-d are filtered and/or the frequency of self-generated noise of the acoustic sensor array 100a, b. In some embodiments, the high-pass filter 1400 may have a cutoff frequency of 300 Hz. Accordingly, the frequencies in the acoustic data 700a-d that are below 300 Hz would be attenuated and the frequencies in the acoustic data 700a-d above 300 Hz maintained (i.e., passed through). Though the high-pass filter 1400 is shown in FIG. 14 as being applied to the acoustic data 700a-d prior to other processes, the high-pass filter 1400 may be applied at a different point within the process without departing from the scope of the disclosure.

Following filtering, the second acoustic data 700b may be shifted to be substantially in-phase with the first acoustic data 700a using the first distance 210 or vice versa. Further, the fourth acoustic data 700d may be shifted to be substantially in-phase with the third acoustic data 700c using the second distance 215 or vice versa.

Once the first and second acoustic data 700a, b are substantially in-phase, a first beamformer 1405a may be applied to the first and second acoustic data 700a, b. Once the third and fourth acoustic data 700c, d are substantially in-phase, a second beamformer 1405b may be applied to the third and fourth acoustic data 700c, d. As previously described, first and second beamformers 1405a, b are designed for each FOV 1010a-d such that beams output from each beamformer 1405a, b are oriented within each FOV 1010a-d as defined by a “look” direction 1000a, b. Accordingly, the design of the first and second beamformers 1405a, b associated with the first FOV 1010 a is different than the design of the first and second beamformers 1405a, b associated with the second FOV 1010b as the first and second FOVs 1010a, b are associated with different “look” directions 1000a, b. Note, in some embodiments, the first and/or second beamformer 1405a, b may include shifting the first or second acoustic data 700a, b to be substantially in-phase and shifting the third or fourth acoustic data 700c, d to be substantially in-phase as a part of beamforming. However, shifting the phase of any of the acoustic data 700a-d such that the manifestation of the acoustic wave of interest 705 is substantially aligned is not a requirement for use of the first and second beamformers 1405a, b. In this regard, other suitable first and second beamformers 1405a, b may perform better when shifting the phase such that the noise field is substantially aligned in juxtaposition to shifting the phase such that the manifestation of the acoustic wave of interest 705 is substantially aligned.

Following beamforming, a post-filter 1410 may be applied to the first beams 1020 output from the first beamformer 1405a and second beams output from the second beamformer 1405b. The post-filter 1410 may be any filter that compensates for the insensitivity of the acoustic sensor array 100a, b to progressively lower frequencies, such as may be needed for differential beamforming. For example, a post-filter 1410 with a 1/frequency response may be used. That is, gain may be progressively increased as frequency progressively decreases.

Following post-filtering, the first intermediate acoustic data 1100a may be shifted to be substantially in-phase with the second intermediate acoustic data 1100b using the third distance 220 or vice versa.

Following phase shifting, a low-pass filter 1415 may be applied to each of the intermediate acoustic data 1100a, b. Any low-pass filter 1415 known to a person of ordinary skill in the art with any cutoff frequency may be used. However, the cutoff frequency may be based on the bandwidth of the acoustic wave of interest 135 such that the bandwidth of the acoustic wave of interest 135 is maintained once the intermediate acoustic data 1100a, b are filtered and/or the spatial aliasing frequency limit. In some embodiments, the low-pass filter 1415 may have a cutoff frequency of 3 kHz. Accordingly, the frequencies in the intermediate acoustic data 1100a, b that are above 3 kHz would be attenuated and the frequencies in the intermediate acoustic data 1100a, b below 3 kHz maintained (i.e., passed through). Though the low-pass filter 1415 is shown in FIG. 14 as being applied to the intermediate acoustic data 1100a, b prior to a MISO approach 1420, the low-pass filter 1415 may be applied at a different point within the process without departing from the scope of the disclosure. A benefit of the low-pass filter 1415 may be to restrict all decision making inside the MISO approach 1420 to intermediate acoustic data 1100 within a relevant bandwidth.

Following filtering, the MISO approach 1420 may be applied to the first and second intermediate acoustic data 1100a, b to further attenuate the noise 150 and thereby determine filtered acoustic data 1200.

This process is repeated using the first through fourth acoustic data 700a-d for the second FOV 1010b as shown by the second FOV block in FIG. 14. Accordingly, filtered data 1200 is determined for each FOV 1010a, b. The filtered data 1200 for all FOVs 1010a, b thus have intensity diversity relative to one another.

FIG. 15 describes the disclosed method in accordance with one or more embodiments. Though the steps of the disclosed method are described in series below, one or more steps may be performed in parallel. Further, the disclosed method may be performed in real time.

In step 1500, the acoustic sensor array 100a detects an acoustic wave. That is, each acoustic sensor 130a-d among the acoustic sensor array 100a detects the acoustic wave at a unique phase due to the spacing of the acoustic sensors 130a-d. The acoustic wave includes an acoustic wave of interest 135 emitted from a source of interest 140 and, in some embodiments, noise 150.

In step 1505, the acoustic sensor array 100a converts the acoustic wave to acoustic data 700. Specifically, the first acoustic sensor 130a converts the acoustic wave to first acoustic data 700a. The second acoustic sensor 130b converts the acoustic wave to second acoustic data 700b. The third acoustic sensor 130c converts the acoustic wave to third acoustic data 700c. The fourth acoustic sensor 130d converts the acoustic wave to fourth acoustic data 700d. To do so, in some embodiments, each acoustic sensor 130a-d may be configured to vibrate or deform in response to the acoustic wave that is then converted into an electrical signal in the form of the acoustic data 700.

In some embodiments, steps 1510, 1515, 1520, 1525, and 1530 may be performed using the DSP 405.

In step 1510, the DSP 405 receives the first through fourth acoustic data 700 from the acoustic sensor array 100a. Specifically, the DSP 405 receives the first acoustic data 700a from the first acoustic sensor 130a, the second acoustic data 700b from the second acoustic sensor 130b, the third acoustic data 700c from the third acoustic sensor 130c, and the fourth acoustic data 700d from the fourth acoustic sensor 130d.

Steps 1515, 1520, and 1525 are performed for each of multiple FOVs 1010a, b. As described relative to FIG. 10, each FOV 1010a, b is defined by a predetermined “look” direction 1000a, b and predetermined aperture 1005.

In step 1515, first beams 1020 are determined using the first and second acoustic data 700a, b and second beams are determined using the third and fourth acoustic data 700c, d. To determine the first beams 1020, a first beamformer 1405a may be designed that directs the first and second acoustic data 700a, b towards a first “look” direction 1000a that defines, in part, a first FOV 1010a as illustrated in FIG. 10. In some embodiments, the first beamformer 1405a may rely on the first distance 210 between the first and second acoustic sensors 130a, b to shift the first or second acoustic data 700a, b such that the first and second acoustic data 700a, b are substantially in-phase. To determine the second beams, a second beamformer 1405b may be designed that directs the third and fourth acoustic data 700c, d towards the same first “look” direction 1000a that the first beams 1020 are directed towards. In some embodiments, the second beamformer 1405b may rely on the second distance 215 between the third and fourth acoustic sensors 130c, d to shift the third and fourth acoustic data 700c, d such that the third and fourth acoustic data 700c, d are substantially in-phase. Accordingly, the first beams 1020 and second beams are directed towards the first “look” direction 1000a. The first and second beamformers 1405a, b may be further designed such that a first beam among the first beams 1020 and a second beam among the second beams have the same unique null angle. A first beam and second beam with the same unique null angle is denoted a “beam pair.”

Step 1515 is performed for a second FOV 1010b, where the second FOV 1010b is defined by a second predetermined “look” direction 1000b.

In step 1520, first intermediate acoustic data 1100a are determined using the first beams 1020 and second intermediate data 1100b are determined using the second beams. To do so, in some embodiments, multiplexing the first beams 1020 may be performed such that each sample of a first mixed beam has the minimum energy among the first beams 1020 at that sample. Further, in some embodiments, multiplexing the second beams may be performed such that each sample of a second mixed beam has the minimum energy among the second beams at that sample. Such a process may be referred to as crossfading. The first mixed beam is denoted the first intermediate acoustic data 1100a. The second mixed beam is denoted the second intermediate acoustic data 1100b.

In step 1525, filtered acoustic data 1200 is determined using the first and second intermediate acoustic data 1100a, b. In some embodiments, this step may be performed using a MISO approach 1420, such as multi-beam. The MISO approach 1420 may rely on the third distance 220 between the first and second pairs of acoustic sensors 125a, b to shift the first or second intermediate acoustic data 1100a, b such that the first and second intermediate acoustic data 1100a, b are substantially in-phase. In some embodiments, the MISO approach may determine third beams using the first and second intermediate acoustic data 1100a, b and the third beams used, in part, to determine the filtered acoustic data 1200. The third beams may form a main lobe 1025 directed towards the corresponding “look” direction 1000a, b associated with the current FOV 1010a, b. In some embodiments, the

Due to the low coherence between the first and second intermediate acoustic data 1100a, b relative to the noise 150, the noise 150 in the filtered acoustic data 1200 may be attenuated relative to the first and second intermediate acoustic data 1100a, b. Accordingly, the filtered acoustic data 1200 may have a high SNR relative to the first through fourth acoustic data 700a-d and first and second intermediate acoustic data 1100a, b.

In step 1530, an AOA 165 of the source of interest 140 relative to the acoustic sensor array 100a is determined using the filtered acoustic data 1200 for the two or more FOVs 1010a, b. In some embodiments, the filtered acoustic data 1200 for the two or more FOVs 1010a, b may be input into a detection algorithm to produce the AOA 165. Accordingly, the intensity diversity of the filtered acoustic data 1200 for the two or more FOVs 1010a, b is exploited by the detection algorithm—an untraditional AOA method—as opposed to phase diversity that traditional AOA methods exploit.

In some embodiments, the detection algorithm may rely on artificial intelligence or machine learning (ML). That is, in some embodiments, the filtered acoustic data 1200 for the two or more FOVs 1010a, b may be input into a trained ML model such that the trained ML model produces the AOA 165 of the source of interest 140. In some embodiments, the ML model may be trained using training data. The training data may include filtered acoustic data 1200 for two or more FOVs 1010a, b, where the acoustic data 700 is collected in the real world or simulated, and known AOAs 165 of the source of interest 140 that emitted the acoustic wave of interest 135. In some embodiments, the ML model may be or include a neural network, such as a convolutional neural network (CNN) or recurrent neural network (RNN). In some embodiments, the detection algorithm may additionally or alternatively determine the DOA 170 of the source of interest 140.

In some embodiments, a reaction plan may be determined based on the AOA 165 and/or DOA 170 of the source of interest 140. Reaction plans are previously discussed relative to FIG. 1. For example, the reaction plan may include avoiding an intersection between a vehicle 110 the acoustic sensor array 100a is disposed on and the source of interest 140. Accordingly, the vehicle 110 may perform the reaction plan by stopping (i.e., auto-braking) the vehicle 110 to stop the vehicle 110 from intersecting with the source of interest 140.

In summary, the disclosed acoustic sensor array 100a, b and method of processing acoustic data collected by the same may be used to attenuate noise 150 and determine filtered acoustic data 1200 with intensity diversity. To do so, the method may capitalize on the coherence characteristics of the acoustic data 700 and beamforming based on FOVs 1010a, b. Though the method destroys the phase diversity of the acoustic data 700 that traditional AOA methods exploit, the detection algorithm used exploits the intensity diversity of the filtered acoustic data 1200 instead.

Although only a few example embodiments have been described in detail above, those skilled in the art will readily appreciate that many modifications are possible in the example embodiments without materially departing from the scope of the disclosure. Accordingly, all such modifications are intended to be included within the scope of this disclosure as defined in the following claims.

What is claimed is:

1. A system comprising:
an acoustic sensor array comprising:
a first pair of acoustic sensors comprising a first acoustic sensor and a second acoustic sensor,
wherein the first acoustic sensor and the second acoustic sensor are configured to detect an acoustic wave and convert the acoustic wave to first acoustic data and second acoustic data, respectively;
wherein the first acoustic sensor has a first center, the second acoustic sensor has a second center, and the first center is located at a first distance of 10 to 75 millimeters, inclusive, from the second center; and
wherein the acoustic wave comprises an acoustic wave of interest emitted from a source of interest, and
a second pair of acoustic sensors comprising a third acoustic sensor and a fourth acoustic sensor,
wherein the third acoustic sensor and the fourth acoustic sensor are configured to detect the acoustic wave and convert the acoustic wave to third acoustic data and fourth acoustic data, respectively; and
wherein the third acoustic sensor has a third center, the fourth acoustic sensor has a fourth center, and the third center is located at a second distance of 10 to 75 millimeters, inclusive, from the fourth center;
a digital signal processor communicably coupled to the acoustic sensor array and configured to execute computer-readable code, the computer-readable code causing the digital signal processor to:
receive, from the acoustic sensor array, the first acoustic data, the second acoustic data, the third acoustic data, and the fourth acoustic data, and
for each of a plurality of fields of view:
determine, using the first distance, a first plurality of beams using the first acoustic data and the second acoustic data and determine, using the second distance, a second plurality of beams using the third acoustic data and the fourth acoustic data,
wherein the first plurality of beams and the second plurality of beams are directed towards each of the plurality of fields of view;
determine first intermediate acoustic data and second intermediate acoustic data using the first plurality of beams and the second plurality of beams, respectively; and
determine, using a third distance, filtered acoustic data based on the first intermediate acoustic data and the second intermediate acoustic data,
wherein a fifth center of the first pair of acoustic sensors is located at the third distance of to 400 millimeters from a sixth center of the second pair of acoustic sensors.

2. The system of claim 1, wherein the first distance is of 20 to 40 millimeters, inclusive.

3. The system of claim 1, wherein the second distance is of 20 to 40 millimeters, inclusive.

4. The system of claim 1, wherein each of the first acoustic sensor, the second acoustic sensor, the third acoustic sensor, and the fourth acoustic sensor comprises an omnidirectional acoustic sensor.

5. The system of claim 1, wherein each of the first acoustic data, the second acoustic data, the third acoustic data, and the fourth acoustic data comprises noise.

6. The system of claim 1, wherein the acoustic sensor array further comprises the digital signal processor.

7. The system of claim 1, wherein the computer-readable code further causes the digital signal processor to determine, using a detection algorithm, an angle of arrival of the source of interest relative to the acoustic sensor array using, at least in part, the filtered acoustic data for the plurality of fields of view.

8. A vehicle comprising:
a body;
a motor configured to propel the body;
an acoustic sensor array disposed and recessed, at least in part, within the body, wherein the acoustic sensor array comprises:
a first pair of acoustic sensors comprising a first acoustic sensor and a second acoustic sensor,
wherein the first acoustic sensor and the second acoustic sensor are configured to detect an acoustic wave and convert the acoustic wave to first acoustic data and second acoustic data, respectively;
wherein the first acoustic sensor has a first center, the second acoustic sensor has a second center, and the first center is located at a first distance of 10 to 75 millimeters, inclusive, from the second center; and
wherein the acoustic wave comprises an acoustic wave of interest emitted from a source of interest, and
a second pair of acoustic sensors comprising a third acoustic sensor and a fourth acoustic sensor,
wherein the third acoustic sensor and the fourth acoustic sensor are configured to detect the acoustic wave and convert the acoustic wave to third acoustic data and fourth acoustic data, respectively; and
wherein the third acoustic sensor has a third center, the fourth acoustic sensor has a fourth center, and the third center is located at a second distance of 10 to 75 millimeters, inclusive, from the fourth center;
a digital signal processor communicably coupled to the acoustic sensor array and configured to execute computer-readable code, the computer-readable code causing the digital signal processor to:
receive, from the acoustic sensor array, the first acoustic data, the second acoustic data, the third acoustic data, and the fourth acoustic data, and
for each of a plurality of fields of view:
determine, using the first distance, a first plurality of beams using the first acoustic data and the second acoustic data and determine, using the second distance, a second plurality of beams using the third acoustic data and the fourth acoustic data,
wherein the first plurality of beams and the second plurality of beams are directed towards each of the plurality of fields of view;
determine first intermediate acoustic data and second intermediate acoustic data using the first plurality of beams and the second plurality of beams, respectively; and
determine, using a third distance, filtered acoustic data based on the first intermediate acoustic data and the second intermediate acoustic data,
wherein a fifth center of the first pair of acoustic sensors is located at the third distance of 75 to 400 millimeters from a sixth center of the second pair of acoustic sensors.

9. The vehicle of claim 8, wherein the body comprises a barrier, and
wherein the acoustic sensor array is disposed and recessed, at least in part, within the barrier.

10. The vehicle of claim 9, wherein the barrier comprises a bumper.

11. The vehicle of claim 8, wherein the body comprises a front barrier and a back barrier,
wherein the acoustic sensor array further comprises a third pair of acoustic sensors and a fourth pair of acoustic sensors,
wherein the first pair of acoustic sensors and the second pair of acoustic sensors are disposed and recessed within the front barrier, and
wherein the third pair of acoustic sensors and the fourth pair of acoustic sensors are disposed and recessed within the back barrier.

12. The vehicle of claim 8, wherein the computer-readable code further causes the digital signal processor to determine, using a detection algorithm, an angle of arrival of the source of interest relative to the acoustic sensor array using, at least in part, the filtered acoustic data for the plurality of fields of view.

13. The vehicle of claim 12, wherein the computer-readable code further causes the digital signal processor to:
determine a reaction plan based, at least in part, on the angle of arrival; and
perform, using the vehicle, the reaction plan.

14. The vehicle of claim 13, wherein the reaction plan comprises avoiding an intersection between the vehicle and the source of interest.

15. A method using a system, the system comprising:
an acoustic sensor array comprising:
a first pair of acoustic sensors comprising a first acoustic sensor and a second acoustic sensor,
wherein the first acoustic sensor and the second acoustic sensor are configured to detect an acoustic wave and convert the acoustic wave to first acoustic data and second acoustic data, respectively;
wherein the first acoustic sensor has a first center, the second acoustic sensor has a second center, and the first center is located at a first distance of 10 to 75 millimeters, inclusive, from the second center; and
wherein the acoustic wave comprises an acoustic wave of interest emitted from a source of interest, and
a second pair of acoustic sensors comprising a third acoustic sensor and a fourth acoustic sensor,
wherein the third acoustic sensor and the fourth acoustic sensor are configured to detect the acoustic wave and convert the acoustic wave to third acoustic data and fourth acoustic data, respectively; and
wherein the third acoustic sensor has a third center, the fourth acoustic sensor has a fourth center, and the third center is located at a second distance of 10 to 75 millimeters, inclusive, from the fourth center,
wherein a fifth center of the first pair of acoustic sensors is located at a third distance of 75 to 400 millimeters from a sixth center of the second pair of acoustic sensors; and
a digital signal processor communicably coupled to the acoustic sensor array;
wherein the method comprises, using the acoustic sensor array:
detecting the acoustic wave,
converting the acoustic wave to the first acoustic data, the second acoustic data, the third acoustic data, and the fourth acoustic data, and
using the digital signal processor:
receiving, from the acoustic sensor array, the first acoustic data, the second acoustic data, the third acoustic data, and the fourth acoustic data; and
for each of a plurality of fields of view:
determining, using the first distance, a first plurality of beams using the first acoustic data and the second acoustic data and determining, using the second distance, a second plurality of beams using the third acoustic data and the fourth acoustic data,
wherein the first plurality of beams and the second plurality of beams are directed towards each of the plurality of fields of view,
determining first intermediate acoustic data and second intermediate acoustic data using the first plurality of beams and the second plurality of beams, respectively, and
determining, using the third distance, filtered acoustic data based on the first intermediate acoustic data and the second intermediate acoustic data.

16. The method of claim 15, further comprising determining, using a detection algorithm, an angle of arrival of the source of interest relative to the acoustic sensor array using, at least in part, the filtered acoustic data for the plurality of fields of view.

17. The method of claim 15, further comprising: applying a filter to the first intermediate acoustic data and applying the filter to the second intermediate acoustic data.

18. The method of claim 15, wherein each of a plurality of beam pairs has a unique null angle relative to a first field of view among the plurality of fields of view, and
wherein each of the plurality of beam pairs comprises a first beam among the first plurality of beams and a second beam among the second plurality of beams.

19. The method of claim 15, wherein each of the first plurality of beams comprises an energy at each of a plurality of samples; and
wherein determining the first intermediate acoustic data comprises:
for each of the plurality of samples, selecting a first beam among the first plurality of beams with a first minimum energy, and
determining a first mixed beam by crossfading the first beam for the plurality of samples together.

20. The method of claim 19, wherein determining the filtered acoustic data comprises:
for each of the plurality of samples, selecting a third beam among a third plurality of beams with a second minimum energy; and
determining a mixed beam by crossfading the third beam for the plurality of samples together.
